(19) United States
(12) Patent Application Publication
(10) Pub. No.: US 2010/0214578 A1
(43) Pub. Date: Aug. 26, 2010

(54) METHOD FOR EVALUATION OF APPLIANCE ECONOMICS AND ENVIRONMENTAL IMPACT

(75) Inventors: John Lewnard, Inverness, IL (US); Dan LeFevers, Edgewater, MD (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE, Des Plaines, IL (US)

(21) Appl. No.: 12/391,279

(22) Filed: Feb. 24, 2009

(51) Int. Cl. G06Q 10/00; G06Q 50/00; G06Q 30/00; H04N 1/60

(52) U.S. Cl. 358/1.9; 705/7; 705/14.1; 705/1.1; 705/347

(57) ABSTRACT

A method and system for determining appliance economics and environmental impacts of appliances comprising the steps of electronically reading an appliance identifier of an appliance using a portable, hand-held communication device, inputting an installation location of the appliance into the communication device, transmitting the appliance identifier and the installation location of the appliance to a data processing center containing current energy cost data and externalities data for the installation location, and transmitting at least one of said appliance economics and said appliance environmental impact for the appliance to the communication device.

### BACKGROUND OF THE INVENTION

1. Field of the Invention

This invention relates to a method and system for automatically providing information to consumers/purchasers at the point of sale relating to purchasing and operating costs as well as environmental impact of appliances. More particularly, this invention relates to a method and system for automatically providing information to consumers relating to the economics, including purchase price, unit life expectancy, installation costs and operating costs, and environmental impact of appliances of interest to the consumer at the point and time of sale.

As the amount of fossil fuel available for consumption decreases and the environmental impact of fossil fuel consumption increases, there is a desire and an on-going effort to reduce the energy consumption and environmental impact, also referred to herein as the environmental footprint, of appliances. In addressing these issues, the choice of specific appliances by the consumer is a critical factor. In particular, consumers require accurate information, tied to their specific locality, regarding the costs and environmental impacts of their purchasing decision in order to make an informed decision. Ideally, this information also would include incentives and/or penalties associated with products having certain characteristics. For example, incentives may be applied to appliances having a low carbon footprint while penalties, such as a luxury tax, may be applied to appliances which are relatively inefficient. However, present day means for obtaining this information are limited, not only in terms of the mechanisms available for obtaining this information, but also in terms of the amount and type of information available.

Most appliances today which meet certain energy consumption requirements may be labeled with an ENERGY STAR® logo. The ENERGY STAR program is intended to provide consumers with greater options for purchasing energy efficient products to save money and energy. More stringent ENERGY STAR criteria for appliances means consumers can make smarter energy choices and help further the goal of increasing efficiency, resulting in significant energy savings. Moreover, as the efficiency of energy consuming products increases, the environmental footprints of the products are reduced.

Appliances also are provided with an EnergyGuide label, which shows the amount of energy consumed by the particular appliance as well as the annual cost to operate the appliance, thereby enabling consumers to compare the energy consumption and operating costs of several comparable appliances. However, one of the limitations of the EnergyGuide label is that the energy costs are based on national averages, assuming “typical” users with respect to items such as number of people using the appliance, dimensions of the space in which the appliance is used, and the like, and, thus, may not provide an accurate picture of the energy consumption and cost for a particular location or user. This is further complicated by the fact that factors affecting energy costs at the local level, such as local energy taxes and rebates, which may be considerable, are not considered when determining the energy costs displayed by the EnergyGuide label. As a result, the appliance purchaser, when trying to decide which appliance from a group of appliances under consideration to purchase, does not have the necessary information to make an informed decision and, thus, may end up making the wrong decision. For example, typically, electric appliances, such as electric water heaters, are generally less expensive to buy than gas water heaters, but the EnergyGuide label for comparable electric and gas appliances shows higher energy costs associated with the electric appliance. From this information alone, a purchaser may decide that, if the difference in listed energy costs is small, then it may make sense to purchase the cheaper electric appliance. However, depending upon the location of the water heater, purchase of the gas appliance could be a better choice. In areas where electricity is relatively cheap, such as areas in which the source of electricity is hydropower, the actual energy costs would be expected to be lower than shown on the EnergyGuide label, in which case, from an economic perspective, purchase of the electric appliance makes sense. However, in areas of the country where electricity is relatively expensive, the actual energy costs would be expected to be higher than shown on the EnergyGuide label, in which case purchase of the gas appliance may be a better choice. Because such information regarding local energy costs is not reflected in the energy costs shown on the EnergyGuide label, the purchaser is unable to make an informed decision and, thus, could end up making the wrong decision.

In addition to appliance costs, there is also the issue of environmental impact, or environmental footprint, of the appliance, for which there is no readily available information. Thus, the consumer has no idea as to, for example, the carbon and/or CO₂ footprint of an appliance, in general, much less the carbon and/or CO₂ footprint of the appliance based on local information and conditions, such as the source of energy for the appliance. In addition to the altruistic desire of consumers to reduce greenhouse gases, there may be economic incentives, such as tax credits, associated with the purchase of appliances which are deemed to be more environmentally friendly, such as appliances having smaller CO₂ footprints.

Additional disadvantages of currently employed systems include the fact that they are manual systems, they are not updated in real time, and they are ad-hoc. In addition, there is insufficient information power available to provide real-time information on costs, rebates, and environmental footprints as well as other related information for specific locations at the point and time of purchase. Finally, none of the systems at present have the capability of providing environmental impact information.

### SUMMARY OF THE INVENTION

Accordingly, it is one object of this invention to provide a method and system for providing appliance economics and environmental impact information to consumers purchasing appliances in real time.

It is another object of this invention to provide a method and system for providing appliance economics and environmental impact information at the point of sale.

It is yet another object of this invention to provide a method and system for providing appliance economics and environmental impact information based upon the location of installation of the appliance.

It is still another object of this invention to provide a method and system for providing appliance economics and environmental impact information based upon user profiles.

These and other objects of this invention are addressed by a method for determining and evaluating appliance economics and environmental impact comprising the steps of electronically reading an appliance identifier of an appliance using a portable, hand-held communication device, inputting an installation location of the appliance and, in accordance with one embodiment of this invention, user profile information of the purchaser into the communication device, transmitting the appliance identifier, installation location, and user profile information to a data processing center containing current energy cost data and externalities data and transmitting at least one of the appliance economics and the appliance environmental impact data for the appliance to the communication device for immediate communication to the consumer/purchaser. As used herein, the term “appliance economics” refers to purchase price, unit life expectancy, installation costs and operating costs of an appliance. As used herein, the term “externalities” refers to the positive and/or negative consequences of economic activity that are experienced by unrelated third parties. Exemplary of such externalities include, but are not limited to, environmental impact or footprint and other consequences of items such as rebates, tax benefits for the installation location. Other relevant information for the installation location utilized in accordance with embodiments of this invention may include elements such as atmospheric conditions, energy sources, and user profile.

The system for carrying out this method comprises an electronic data processing center containing data on current energy costs and appliance externalities, e.g. carbon footprint, an electronic communication device in communication with the electronic data processing center, the electronic communication device comprising means for reading appliance identifiers of the appliances, means for recording appliance installation locations of the appliances, and means for transmitting the identifiers and locations to the electronic data processing center, and the electronic data processing center comprising an algorithm for determining at least one of appliance economics and appliance environmental impact of the appliance, and means for transmitting the appliance economics and appliance environmental impact of the appliance to the electronic communication device.

### BRIEF DESCRIPTION OF THE DRAWINGS

These and other objects and features of this invention will be better understood from the following detailed description taken in conjunction with the drawings wherein:

FIG. 1 is a schematic diagram of a system for determining and evaluating appliance economics and environmental impact in real time in accordance with one embodiment of this invention.

### DETAILED DESCRIPTION OF THE PRESENTLY PREFERRED EMBODIMENTS

This invention is a method and system for automatically providing information at the location and time of sale for appliances with respect to the purchasing and operating costs and/or environmental footprint of the appliances. This information is time-specific, location-specific, and may be user-specific, and is directly tied to the particular model of an appliance. The system provides information directly to the consumer/purchaser in formats that are commonly accepted, e.g. printouts of analog and/or tabular data. It also provides a database of consumer information that can be used by others, such as utilities, regulators, and manufacturers, to help further refine energy and environmental policy and planning. Because the system is simple and automated, it provides value to all stakeholders. Revenues may accrue to the service provider, for example, as a surcharge on the purchase, through a subscription service, or through a government-supported fee structure. In addition to being simple for consumers, retailers, and stakeholders seeking purchase information, the system of this invention provides for uniformity of information formatting to support good decision making by consumers and others using the system.

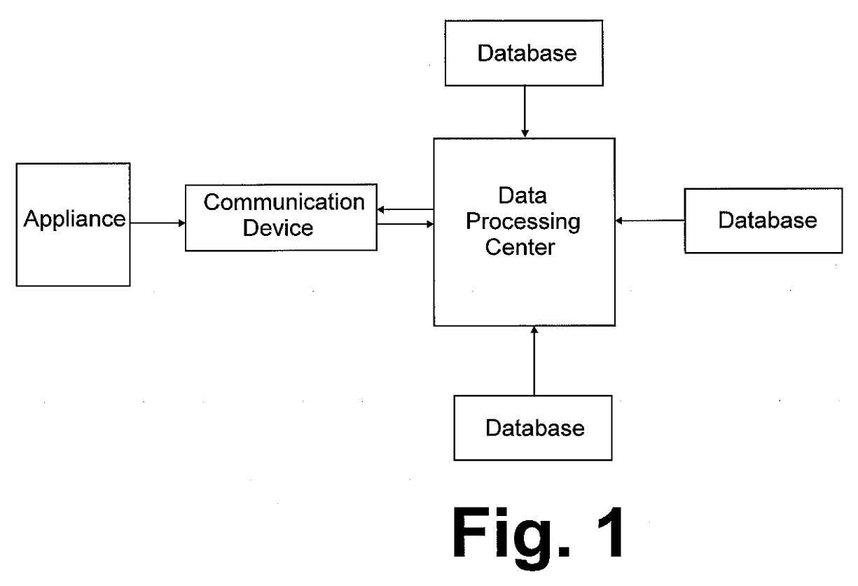

FIG. 1 is a schematic diagram of a system in accordance with one embodiment of this invention for carrying out the method of this invention. As shown therein, the system comprises a communication device into which information about the appliance, including the particular appliance model and the location of installation of the appliance is input. Additional information that may be communicated includes a profile of the potential consumer or purchaser, such as number of users, type of building, e.g. condominium, single family dwelling, etc., and square footage associated with the installation location. In accordance with one preferred embodiment of this invention, the communication device is a portable, hand-held device which reads the appliance identification information, such as may be provided by a universal product code (UPC), which is an identifier of a particular product that enables the product to be tracked, at the point of sale and into which information regarding the appliance installation location, user profile, and the like is input. Included within the appliance identification information, in addition to appliance model number, is information relating to energy utilization, such as an energy efficiency rating, form of energy, e.g. natural gas, propane, electricity, etc. In accordance with one particularly preferred embodiment, the communication device is a wireless device capable of both transmitting and receiving information by means of wireless communications.

In addition to the communication device, the system of this invention comprises a data processing center with which the communication device is in communication. Information regarding the appliance and its installation location is transmitted by the communication device to the data processing center, which preferably is a central data processing center into which all the information from all of the communication devices in service may be transferred. The data processing center comprises a computer having an algorithm for determining the estimated energy costs for operation of the appliance at the location of installation. The algorithm may also provide an indication of relative cost savings compared either with a predetermined baseline or, preferably, a comparison appliance. And, based upon the amount of energy consumed by the appliance, as well as the source of the energy, e.g. electricity generated by fossil fuels, nuclear energy, hydropower, wind power, etc., the carbon footprint of the appliance can also be determined.

The data processing center comprises a database of product-related information from which the information to the consumer is provided. One of the objectives of this invention is to provide information to the consumer that is independently certified for integrity and accuracy, thereby providing a common standard and platform for the nationwide or international retail market. This objective is addressed by the data processing center having access to independent, verifiable sources of data. By way of examples, databases providing product rated performance and efficiency information for appliances such as water heaters and air conditioning and heating appliances are available from the Air-Conditioning, Refrigeration and Heating Institute (AHRI), U.S. Department of Energy, and the U.S. Federal Trade Commission. For providing information relating to environmental footprint, the Emissions & Generation Resource Integrated Database (eGRID), a U.S. Environmental Protection Agency database, is a comprehensive inventory of environmental attributes of electric power system. based on available plant-specific data for all U.S. electricity generating plants that provide power to the electric grid and report data to the U.S. government. eGRID contains air emissions data for nitrogen oxides (NOₓ), sulfur dioxide (SO₂), carbon dioxide (CO₂), mercury (Hg), methane (CH₄) and nitrous oxide (N₂O). Other sources including the National Renewable Energy Laboratory (NREL), the North American Electric Reliability Council, State governmental agencies, and individual utility databases may be used as a means for localizing the information provided by eGRID. For information relating to environmental conditions, e.g. heating days, temperatures, which impact local considerations, there are databases of the National Weather Service, National Oceanic and Atmospheric Administration.

In addition to energy related information, the data processing center includes communication with databases providing the latest rebate information, carbon tax, financial incentives, and financial penalties associated with the specific appliance of interest to the consumer. For information related to rebates, there are the internal databases of the appliance stores, manufacturers, and local utilities. This information is transmittable to the communication device at the point of sale, thereby enabling the consumer to have as much information as possible to make an informed decision regarding the appliance purchase.

In accordance with one embodiment of this invention, the system is configured to automatically process rebate forms at the time of purchase of the appliance, thereby ensuring that the consumer actually receives the benefit of the rebate. In accordance with another embodiment of this invention, the system further comprises means to allow collation of statistical data regarding purchase inquiries and actual purchases that may be analyzed and developed as a separate offering to stakeholders, including energy regulatory agencies, utilities, local planning commissions, retailers, and manufacturers to help further refine energy policy and planning.

As previously indicated, the system is capable of providing information directly to the consumer in formats that are commonly accepted. In accordance with one embodiment of this invention, the information may be provided in an analog form, such as a color coding or “energy star” type of rating. In accordance with another embodiment of this invention, the information may be provided in a more detailed format, such as a tabular format.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A system for evaluating appliance economics and environmental impact of an appliance at a location and time of sale of said appliance comprising:
an electronic data processing center containing data on current energy costs and appliance externalities;
an electronic communication device in communication with said electronic data processing center, said electronic communication device comprising means for reading appliance identifiers of said appliance, recorded appliance installation locations for said appliance, and means for transmitting said identifiers and locations to said electronic data center; and
said electronic data processing center comprising an algorithm for determining at least one of estimated energy costs, relative cost savings compared with a predetermined baseline or comparison appliance, and environmental impact of said appliance, and means for transmitting said estimated energy costs, relative cost savings, and environmental impact of said appliance to said electronic communication device.

2. The system of claim 1, wherein said electronic communication device further comprises consumer profile information for transmission to said electronic data processing center.

3. The system of claim 1, wherein said communication device comprises printing means for printing out data received from said data processing center.

4. The system of claim 1, wherein said communication device is a wireless communication device.

5. The system of claim 1, wherein said data processing center is a central data processing center.

6. The system of claim 1, wherein said data processing center is in communication with independent, verifiable sources of energy data, appliance pricing data, and environmental impact data.

7. The system of claim 1, wherein said data processing center is in communication with data sources for appliance rebate information, carbon tax information, financial incentive information, and financial penalty information.

8. The system of claim 1, wherein said communication device is adapted to automatically process rebate forms.

9. A method for determining appliance economics and appliance environmental impacts comprising the steps of:
electronically reading an appliance identifier of an appliance using a portable, hand-held communication device;
inputting an installation location of said appliance into said communication device;
transmitting said appliance identifier and said installation location to a data processing center containing current energy cost data and externalities data for said installation location;
calculating at least one of said appliance economics and appliance environmental impact for said appliance; and
transmitting at least one of said appliance economics and said appliance environmental impact for said appliance to said communication device.

10. The method of claim 9, wherein at least one of said appliance economics and said appliance environmental impact is printed out by said communication device.

11. The method of claim 10, wherein said appliance economics and said appliance environmental impact are printed out by said communication device in an analog form.

12. The method of claim 10, wherein said appliance economics and said appliance environmental impact are printed out by said communication device in a tabular form.

13. The method of claim 9, wherein said data processing center is in communication with independent, verifiable sources of energy data, appliance pricing data, and environmental impact data.

14. The method of claim 9 further comprising retrieving data from one or more databases relating to appliance rebates, carbon tax, financial incentives, and financial penalties for said appliance, and printing out said data with said communication device.

15. The method of claim 14 further comprising automatically processing rebate forms using said communication device.

16. The method of claim 9 further comprising inputting user profile information into said communication device and transmitting said user profile information to said data processing center.

17. The method of claim 14 further comprising determining one or more externalities associated with said appliance rebates, carbon tax, financial incentives, and financial penalties for said appliance.
